(19) United States
(12) Patent Application Publication
(10) Pub. No.: US 2026/0335944 A1
(43) Pub. Date: Oct. 29, 2026

(54) High speed air gun

(71) Applicant: Guangzhou Koopoin Technology Co., Ltd., Guangzhou (CN)

(72) Inventors: Bo LI, GUANGZHOU (CN); Wei XIE, GUANGZHOU (CN)

(73) Assignee: Guangzhou Koopoin Technology Co., Ltd., Guangzhou (CN)

(21) Appl. No.: 19/231,431

(22) Filed: Jun. 7, 2025

(30) Foreign Application Priority Data
Apr. 29, 2025 (CN) 2025208551203

(51) Int. Cl. B08B 5/02

(52) U.S. Cl. CPC B08B 5/02

(57) ABSTRACT

The application discloses a high-speed air gun, comprising a main body and at least two fans; the main body is provided with an air duct and an air inlet and an air outlet respectively arranged at both ends of the air duct; the fans are sequentially installed in series in the air duct, and the direction of the air flow output by each fan is toward the air outlet, and a compression chamber is formed in the air duct between adjacent fans. The application has the advantages of high wind speed, good safety and good portability.

### INCORPORATION BY REFERENCE

This application claims priority to China Patent Application No. 2025208551203 filed Apr. 29 2025, the contents of which are hereby incorporated by reference in their entirety.

### TECHNICAL FIELD

The present application relates to the field of air gun technology, and specifically to a high speed air gun.

### BACKGROUND

High-intensity airflow is often used in the fields of industrial cleaning, electronic equipment dust removal, etc. At present, the common high speed airflow generating devices on the market are mainly of the following types:
1. High-pressure air gun: using compressed air or other high-pressure gas as the power source, through the high-pressure gas storage chamber, high-pressure exhaust valve and other components, the high-pressure gas is released instantly to generate high speed airflow, which is often used in cleaning, pneumatic tools and other scenes that require instantaneous high-pressure gas.
2. Compressed gas tank: storing high-pressure gas, releasing gas by controlling the valve, using the expansion of gas to generate power, pushing tools or objects to move, and used in some occasions that require high-pressure gas, such as pneumatic tools, spray painting, etc.
3. high speed air gun with a single DC motor: driving a single DC brushless motor to run at high speed to generate airflow, which is suitable for occasions that require continuous and stable airflow, such as electronic manufacturing, precision machining, etc.

Problems and shortcomings of existing technologies:
1. High-pressure air guns and compressed gas tanks: poor portability, requiring the carrying of gas source equipment, such as air compressors, gas storage tanks, etc. ; there are certain safety hazards during use, such as high-pressure gas leakage, explosion and other risks; and it is unable to provide continuous and stable airflow, and is not suitable for occasions that require long-term stable airflow.
2. high speed air guns with a single DC motor: the current mainstream air guns on the market generally adopt a single motor drive structure, and the outlet wind speed is relatively low.

In view of the defects in the prior art, the present application provides a high speed air gun with high wind speed, good safety and good portability.

The present application provides a high speed air gun, comprising:
A main body, wherein an air duct and an air inlet and an air outlet are respectively arranged at both ends of the air duct;
At least two fans, each of which is installed in series in the air duct in sequence, and the direction of the air flow output by each fan is toward the air outlet, and a compression chamber is formed in the air duct between adjacent fans.

Further, the fan includes:
an annular shell, the annular shell is fixed in the air duct;
a motor, the motor is coaxially arranged in the annular shell, the output shaft of the motor faces one end of the air inlet, an annular flow passage is formed between the motor and the annular shell, and a plurality of guide vanes connected between the motor and the annular shell are distributed in annular intervals in the annular flow passage;
a fan blade, the fan blade is fixed to the output shaft of the motor.

Further, an resilient sealing sleeve is provided between the annular shell and the inner wall of the air duct.

Further, the resilient sealing sleeve adopts a rubber sleeve.

Further, it also includes a jet head, the jet head is connected to the air outlet end of the air duct.

Further, the air inlet end of the air duct is provided with an air inlet grille, and the air outlet end of the air duct is provided with an air outlet grille.

Further, it also includes:
an air inlet ring, one end of which is provided with a first external threaded joint, the air inlet end of the air duct is provided with a first internal threaded interface, the inner end of the first internal threaded interface is provided with a first annular step, the first external threaded joint is threadedly connected to the first internal threaded interface, and the periphery of the air inlet grille is pressed against the first annular step;
an air outlet ring, one end of which is provided with a second external threaded joint, the air outlet end of the air duct is provided with a second internal threaded interface, the second external threaded joint is threadedly connected to the second internal threaded interface, the connecting end of the jet head is provided with a third external threaded joint, the other end of the air outlet ring is provided with a third internal threaded interface, the inner end of the third internal threaded interface is provided with a second annular step, the third external threaded joint is threadedly connected to the third internal threaded interface, and the periphery of the air outlet grille is pressed against the second annular step.

Further, the inner wall of the middle part of the air duct is provided with an annular protrusion.

The fans are provided with two, one of which is located between the air inlet grille and the annular protrusion, and the other is located in front of the annular protrusion.

Further, a handle is also included, and the handle is connected to the outside of the main body.

Further, a control button is provided outside the handle, and the control button is connected to the circuit of the motor to control the on and off of the motor. A power connector is provided at one end of the handle away from the main body to connect the circuit of the motor and the external power cord.

The beneficial effects of the present application are as follows:

The present application adopts at least two-stage fans installed in series in the air duct of the main body, and the air duct between the two motors constitutes a compression chamber. The air sucked in from the air outlet passes through the first fan, and part of the kinetic energy is converted into static pressure in the compression chamber. After the airflow passes through the second fan, it is discharged from the air outlet. In this way, two fans are used to drive the airflow in two stages. The local wind speed of the airflow at the air outlet can be as high as 120 meters per second, which is about 40% higher than the wind speed of a single fan, and can meet the occasions where high wind speed is required. Compared with the high speed airflow generating device of the high-pressure air gun and the compressed gas tank, this application avoids the safety hazards such as high-pressure gas leakage and explosion of the high-pressure air gun and the compressed gas tank, and is safer and more reliable to use. In addition, compared with the high-pressure air gun and the compressed gas tank, the high speed air gun of the present application is lighter and easier to carry and operate.

### DESCRIPTION OF THE DRAWINGS

In order to more clearly illustrate the specific implementation of the present application or the technical solution in the prior art, the drawings required for the specific implementation or the prior art description will be briefly introduced below. In all drawings, similar elements or parts are generally identified by similar figure marks. In the drawings, each element or part is not necessarily drawn according to the actual scale.

FIG. 1 is an assembly diagram of a high speed air gun provided in an embodiment of the present application;

FIG. 2 is an exploded view of a high speed air gun provided in an embodiment of the present application;

FIG. 3 is a longitudinal sectional view of an embodiment of the present application.

In the accompanying drawings, 100—main body; 110—air duct; 120—air inlet; 130—air outlet; 140—compression chamber; 150—first internal thread interface; 151—first annular step; 160—second internal thread interface; 170—annular protrusion; 200—fan; 210—annular shell; 220—motor; 230—annular flow passage; 240—wind guide plate; 250—fan blades; 260—resilient sealing sleeve; 300—jet head; 310—third external thread joint; 400—air inlet grille; 500—air outlet grille; 600—air inlet ring; 610—first external thread joint; 700—air outlet ring; 710—second external thread joint; 720—third internal thread interface; 721—second annular step; 800—handle; 810—control button; 820—power connector.

### DETAILED DESCRIPTION

The following will describe the embodiments of the technical solution of the present application in detail with reference to the accompanying drawings. The following embodiments are only used to more clearly illustrate the technical solution of the present application, and are therefore only examples, and cannot be used to limit the scope of protection of the present application.

It should be noted that, unless otherwise specified, the technical terms or scientific terms used in this application should be the common meanings understood by technicians in the field to which the present application belongs.

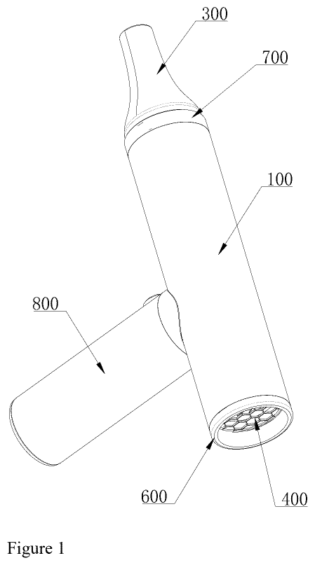

As shown in FIG. 1 to FIG. 3, an embodiment of the present application provides a high speed air gun, including a main body 100 and at least two fans 200.

The main body 100 is in the shape of a circular tube, and is provided with a duct 110 and an air inlet 120 and an air outlet 130 respectively arranged at both ends of the duct 110.

Each fan 200 is sequentially installed in series in the duct 110, and the direction of the air flow output by each fan 200 is toward the air outlet 130, and a compression chamber 140 is formed in the duct 110 between adjacent fans 200.

It should be noted that “at least two fans” means that two, three or even more fans 200 can be provided. In this embodiment, the number of fans 200 is preferably two.

In the embodiment, a two-stage fan 200 is installed in series in the air duct 110 of the main body 100. The air duct 110 between the two motors 220 constitutes a compression chamber 140. The air sucked in from the air inlet 120 passes through the first fan 200, and part of the kinetic energy is converted into static pressure in the compression chamber 140. After the air flow passes through the second fan 200, it is discharged from the air outlet 130. In this way, two fans 200 are used to drive the air flow in two stages. The local wind speed of the air flow at the air outlet 130 can be as high as 120 meters per second, which is about 40% higher than the wind speed of a single fan, and can meet the occasions where high wind speed is required. Compared with the high speed airflow generating device of the high-pressure air gun and the compressed gas tank, the present application avoids the safety hazards of high-pressure gas leakage, explosion and the like of the high-pressure air gun and the compressed gas tank, and is safer and more reliable to use. In addition, compared with the high-pressure air gun and the compressed gas tank, the high speed air gun of the present application is lighter, easier to carry and operate.

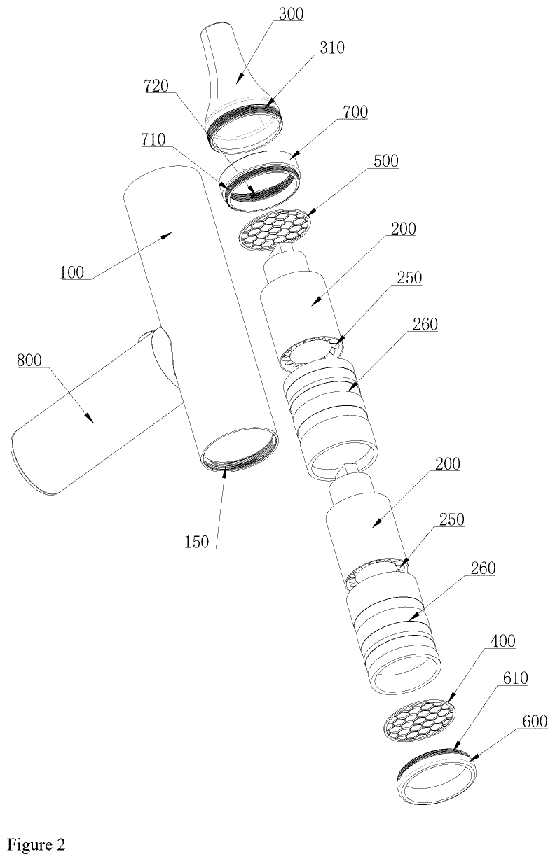

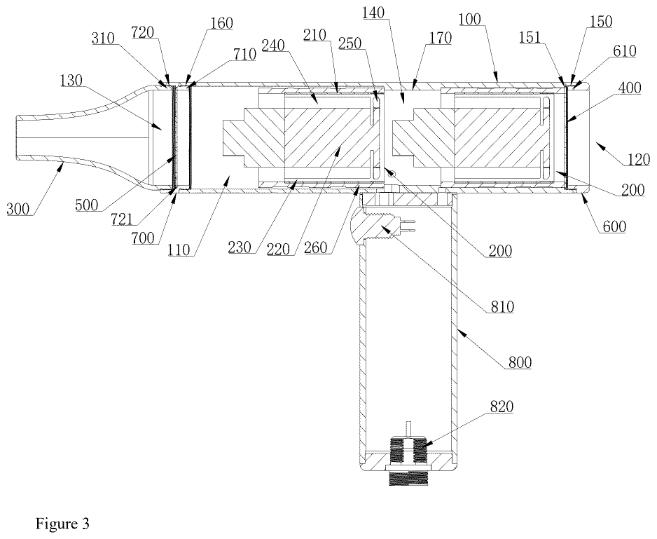

In some embodiments, referring to FIG. 2 and FIG. 3, the fan 200 includes an annular housing 210, a motor 220 and a fan blade 250.

The annular housing 210 is fixed in the air duct 110.

The motor 220 is coaxially arranged in the annular housing 210, and the output shaft of the motor 220 faces one end of the air inlet 120. An annular flow passage 230 is formed between the motor 220 and the annular housing 210, and a plurality of guide vanes 240 connected between the motor 220 and the annular housing 210 are distributed in annular intervals in the annular flow passage 230.

The fan blade 250 passes through the output shaft fixed to the motor 220.

When the motor 220 drives the fan blade 250 to rotate, the fan blade 250 drives the airflow to pass through the annular flow passage 230 between the motor 220 and the annular housing 210, thereby accelerating the airflow from the air inlet 120 to the air outlet 130.

Preferably, an resilient sealing sleeve 260 is provided between the annular housing 210 and the inner wall of the air duct 110, and the resilient sealing sleeve 260 may be a rubber sleeve. By providing the resilient sealing sleeve 260 between the annular housing 210 and the air duct 110, on the one hand, the resilient sealing sleeve 260 can improve the sealing between the fan 200 and the air duct 110, and prevent air leakage between the fan 200 and the air duct 110, and on the other hand, the resilient sealing sleeve 260 has a vibration reduction effect, so that the operation of the high speed air gun is more silent.

In some embodiments, the high speed air gun further includes a jet head 300, which is connected to the air outlet 130 end of the air duct 110. By providing the jet head 300, the speed of the airflow ejected by the air gun can be increased.

In some embodiments, an air inlet grille 400 is provided at the air inlet 120 end of the air duct 110, and an air outlet grille 500 is provided at the air outlet 130 end of the air duct 110. The purpose of providing the air inlet grille 400 and the air outlet grille 500 is to prevent external debris from entering the air duct 110 and affecting the safe operation of the fan 200.

In some embodiments, the high speed air gun further includes an air inlet ring 600 and an air outlet ring 700.

A first external threaded joint 610 is provided at one end of the air inlet ring 600, a first internal threaded interface 150 is provided at the air inlet 120 end of the air duct 110, a first annular step 151 is provided at the inner end of the first internal threaded interface 150, the first external threaded joint 610 is threadedly connected to the first internal threaded interface 150, and the periphery of the air inlet grille 400 is pressed against the first annular step 151.

A second external threaded joint 710 is provided at one end of the air outlet ring 700, a second internal threaded interface 160 is provided at the air outlet end of the air duct 110, the second external threaded joint 710 is threadedly connected to the second internal threaded interface 160, a third external threaded joint 310 is provided at the connection end of the jet head 300, a third internal threaded interface 720 is provided at the other end of the air outlet ring 700, a second annular step 721 is provided at the inner end of the third internal threaded interface 720, the third external threaded joint 310 is threadedly connected to the third internal threaded interface 720, and the periphery of the air outlet grille 500 is pressed against the second annular step 721.

Preferably, an annular protrusion 170 is provided on the inner wall of the middle part of the air duct 110.

Two fans 200 are provided, one of which is located between the air inlet grille 400 and the annular protrusion 170, and the other fan 200 is located in front of the annular protrusion 170.

The tail and head of the high speed air gun can be assembled separately. When assembling the tail of the high speed air gun, a fan 200 can be first installed into the air duct 110 in the main body 100 from the air inlet 120 end, and then the air inlet grille 400 is installed into the first internal thread interface 150 at the air inlet end of the main body 100, and then the first external thread connector 610 on the air inlet ring 600 is screwed into the first internal thread interface 150 at the air inlet end of the main body 100, and the assembly of the tail of the high speed air gun can be completed. When assembling the head of the high speed air gun, first install a fan 200 into the air duct 110 in the main body 100 from the air outlet 130 end, then screw the second external threaded joint 710 on the air outlet ring 700 into the second internal threaded interface 160 at the air outlet end of the main body 100, and then install the air outlet grille 500 into the third internal threaded interface 720 on the air outlet ring 700, and finally screw the third external threaded joint 310 on the jet head 300 into the third internal threaded interface 720 on the air outlet ring 700 to complete the assembly of the high speed air gun head.

In some embodiments, the high speed air gun further includes a handle 800, which is connected to the outside of the main body 100, so that the handle 800 can be conveniently held for operation during use.

Preferably, a control button 810 is provided outside the handle 800, and the control button 810 is connected to the circuit of the motor 220 to control the on and off of the motor 220. A power connector 820 is provided at one end of the handle 800 away from the main body 100 to connect the circuit of the motor 220 and the external power cord.

The motor 220 of this embodiment adopts a 24V DC brushless motor, which is installed in the air duct 110 of the main body 100 in series. The power adapter is connected to the motor 220 through the power cord to ensure that a stable 24V DC power is provided to the motor 220. The control button 810 is installed outside the handle 800 and connected to the circuit of the motor 220 to realize the control of the motor 220. Pressing the control button 810 can turn on the power to make the fan

The method of using the above-mentioned high speed air gun is as follows:
1. Connect the power adapter: insert the power adapter into the power socket and connect the power cord to the air gun.
2. Start the air gun: press the control button 810, the fan 200 in the air gun starts to run at high speed, generates high-speed airflow, and discharges from the air outlet 130.
3. Use the air gun: aim the air gun at the target object as needed, and perform operations such as drying and cleaning.
4. Stop using: release the control button 810, the fan 200 stops running, and the air gun stops working.

Through the above embodiments, the high-speed air gun of the present application can achieve high wind speed, long-term continuous use, safety and reliability, and easy operation, and is suitable for occasions such as electronic manufacturing and precision machining that require high-speed airflow.

Finally, it should be noted that the above embodiments are only used to illustrate the technical solutions of the present application, rather than to limit it. Although the present application has been described in detail with reference to the aforementioned embodiments, those skilled in the art should understand that they can still modify the technical solutions described in the aforementioned embodiments, or replace some or all of the technical features therein by equivalents. These modifications or replacements do not make the essence of the corresponding technical solutions deviate from the scope of the technical solutions of the embodiments of the present application, and they should all be included in the scope of the claims and specification of the present application.

1. A high speed air gun, wherein including a main body, an air duct and an air inlet and an air outlet are respectively arranged at both ends of the air duct; at least two fans, each of the fans is installed in series in the air duct in sequence, a direction of the air flow output of each of the fans is toward the air outlet, and a compression chamber is formed in the air duct between adjacent fans.

2. The high speed air gun according to claim 1, wherein the each of the fans comprises:
an annular shell, the annular shell is fixed in the air duct;
a motor, the motor is coaxially arranged in the annular shell, an output shaft of the motor faces one end of the air inlet, an annular flow passage is formed between the motor and the annular shell, and a plurality of guide vanes connected between the motor and the annular shell are distributed in annular intervals in the annular flow passage;
a fan blade, the fan blade is fixed to an output shaft of the motor.

3. The high speed air gun according to claim 2, wherein an resilient sealing sleeve is arranged between the annular outer shell and the inner wall of the air duct.

4. The high speed air gun according to claim 3, wherein the resilient sealing sleeve is a rubber sleeve.

5. The high speed air gun according to claim 1, wherein also includes a jet head, which is connected to the air outlet end of the air duct.

6. The high speed air gun according to claim 5, wherein an air inlet grille is provided at the air inlet of the air duct, and an air outlet grille is provided at the air outlet of the air duct.

4. The high speed air gun according to claim 6, wherein also including an air inlet ring, one end of which is provided with a first external threaded joint, the air inlet end of the air duct is provided with a first internal threaded interface, the inner end of the first internal threaded interface is provided with a first annular step, the first external threaded joint is threadedly connected to the first internal threaded interface, and the periphery of the air inlet grille is pressed against the first annular step; an air outlet ring, one end thereof is provided with a second external threaded joint, the air outlet end of the air duct is provided with a second internal threaded interface, the second external threaded joint is threadedly connected to the second internal threaded interface, the connection end of the jet head is provided with a third external threaded joint, the other end of the air outlet ring is provided with a third internal threaded interface, the inner end of the third internal threaded interface is provided with a second annular step, the third external threaded joint is threadedly connected to the third internal threaded interface, and the periphery of the air outlet grille is pressed against the second annular step.

8. The high speed air gun according to claim 7, wherein an annular protrusion is provided on the inner wall of the middle part of the air duct; two fans are provided, one of the fans is located between the air inlet grille and the annular protrusion, and the other one of the fans is located in front of the annular protrusion.

9. The high speed air gun according to claim 1, wherein also including a handle, the handle is connected to an outside of the main body.

10. The high speed air gun according to claim 9, wherein the handle is provided with a control button outside, and the control button is connected to the circuit of the motor and is used to control the on and off of the motor. The end of the handle away from the main body is provided with a power connector for connecting the circuit of the motor and an external power cord.
